(19) United States
(12) Patent Application Publication
(10) Pub. No.: US 2017/0276996 A1
(43) Pub. Date: Sep. 28, 2017

(54) MICROCAVITY ARRAY FOR SPECTRAL IMAGING

(71) Applicant: MONTANA STATE UNIVERSITY, Bozeman, MT (US)

(72) Inventors: Russell J. BARBOUR, Bozeman, MT (US); Zeb W. BARBER, Bozeman, MT (US)

(73) Assignee: Montana State University, Bozeman, MT (US)

(21) Appl. No.: 15/506,660

(22) PCT Filed: Aug. 25, 2015
(86) PCT No.: PCT/US2015/046774

§ 371 Date: Feb. 24, 2017

Related U.S. Application Data
(60) Provisional application No. 62/041,529, filed on Aug. 25, 2014.

(51) Int. Cl. G02F 1/1335; G01J 3/28

(52) U.S. Cl. CPC G02F 1/133514; G01J 3/2823; G02F 2001/133521; G01J 2003/2826; G01J 2003/1247

(57) ABSTRACT

Tunable filter arrays include an array of liquid crystal (LC) tunable Fabry-Perot (FP) microcavities. The microcavities are defined by first and second reflectors and an LC layer situated between the reflectors. The tunable filter is secured to an image sensor array so that the LC tunable microcavities are coupled to respective photodetectors of the image sensor array. Patterned electrodes are situated about the LC layer to tune the microcavities.

### CROSS-REFERENCE TO RELATED APPLICATIONS

This application claims the benefit of U.S. Provisional Application 62/041,529, filed Aug. 25, 2014, which is incorporated herein by reference.

### FIELD

The disclosure pertains to spectral imaging.

### BACKGROUND

High resolution spectral imaging systems have numerous potential applications, but typical systems that provide adequate spectral and spatial resolution are often impractical. Spectral analysis can be obtained using diffraction gratings, optical filters, Fabry-Perot interferometers, or other optical systems. Conventional tunable filters such as described in Lin et al., U.S. Pat. No. 7,734,131 and Smith et al., U.S. Patent Publication 2015/0103343 require complex, specialized fabrication processes. For many applications, such conventional systems remain impractical. Systems based on diffraction gratings and optical filters can be inconveniently large and tuning is often slow. Conventional Fabry-Perot interferometer-based systems can be used but conventional Fabry-Perot interferometers are difficult to maintain in alignment and have spectral resolutions that are not suitable for many applications.

### BRIEF SUMMARY OF THE INVENTION

The disclosure pertains to optical devices, methods, and systems for spectral imaging and other applications. According to some examples, optical devices include first and second reflectors and a liquid crystal layer situated between the first and second reflectors. The liquid crystal layer and the first and second reflectors define an optical cavity and first and second conductive electrodes are situated to define a plurality of electrically controllable microcavities in the optical cavity. In some examples, at least one of the first and second conductive electrodes includes a plurality of microcavity electrodes that define the electrically controllable microcavities. In typical examples, at least one of the first and second conductive electrodes is situated external to the optical cavity. In some embodiments, the optical devices include a first transparent substrate, wherein the first reflector is situated at a cavity-facing surface of the first transparent substrate, and a second transparent substrate, wherein the second reflector is situated at a cavity-facing surface of the second transparent substrate. In representative examples, the microcavity electrodes are arranged so as to form a microcavity electrode array, and the cavity-facing surface of the first substrate includes a plurality of concave portions, each concave portion corresponding to a respective microcavity. In some examples, the first and second reflectors are dielectric reflectors having reflectivities of at least 90% in a selected spectral range. According to some embodiments, the first conductive electrode includes a plurality of microcavity electrodes that define the electrically controllable microcavities. The optical devices further include a plurality of transistors, each of the plurality of transistors coupled to a respective microcavity electrode. In some cases, a microlens array is secured to a surface of the first substrate that is opposite the cavity-facing surface, wherein each lens of the microlens array is situated along an axis of a respective microcavity.

Spectral imagers comprise a Fabry-Perot tunable filter having a plurality of liquid crystal tunable microcavities and an image sensor optically coupled to the Fabry-Perot tunable filter. Typically, the image sensor includes plurality of pixels, and the liquid crystal tunable microcavities are situated so as to be optically coupled to corresponding image sensor pixels. In representative examples, the Fabry-Perot tunable filter includes a substrate having a high reflectance coating on a microcavity-facing surface, and the substrate is secured to the image sensor. In some cases, each microcavity is optically coupled to different image sensor pixels. According to further examples, the Fabry-Perot tunable filter includes an array of tunable microcavities and the image sensor includes an array of pixels. In some embodiments, the Fabry-Perot tunable filter includes first and second substrates having high reflectivity coatings on respective microcavity-facing surfaces and a liquid crystal layer is situated between the first and second substrates, and the image sensor includes an image sensor window, further wherein one of the first and second substrates is fixed to the image sensor window.

Methods of making a spectral imager comprise defining an array of LC microcavities and securing the array of LC microcavities to an image sensor array so that LC microcavities are optically coupled to respective sensors of the image sensor array. In some examples, the array of LC microcavities is defined by forming a first reflective coating in a selected spectral region on a first substrate; forming a second reflective coating in the selected spectral region on a second substrate; and situating an LC layer between the first and second reflective coatings. In further examples, the array of LC microcavities is situated between a first conductive coating and a second conductive coating, wherein at least one of the first conductive coating and the second conductive coating is patterned so as to define the LC microcavities. In other examples, an array of regions in a surface of the first substrate is ablated, wherein the first reflective coating is formed on the array of ablated regions. In still further examples, a microlens array is secured with respect to the array of LC microcavities so that the microlenses are situated to direct input optical radiation to associated LC microcavities and corresponding image sensor pixels.

In a representative example, spectral imagers comprise a tunable filter defined by a liquid crystal layer situated between first and second transparent substrates, the first transparent substrate having an array of surface depressions and a dielectric coating at the surface depressions, the second substrate having a dielectric coating, wherein the dielectric coatings of the first and second substrates and the array of depressions define an array of liquid crystal Fabry-Perot cavities. An image array is secured to the tunable filter, so that the liquid crystal Fabry-Perot cavities are optically coupled to corresponding photodetectors of the image array. A piezoelectric device is coupled to at least one of the first and second substrates so as to adjust a spacing of the liquid crystal Fabry-Perot cavities. A liquid crystal driver and a piezoelectric driver are coupled to the tunable filter so as to select a plurality of wavelengths for each of the liquid crystal Fabry-Perot cavities, and a processor receives images from the image array and provides a spectral data cube based on the images.

### BRIEF DESCRIPTION OF THE DRAWINGS

FIG. 1 is a schematic sectional diagram of a representative Fabry-Perot tunable filter that includes a plurality of microcavities.

FIG. 2 illustrates a portion of an active matrix addressed liquid crystal (LC) array for a Fabry-Perot tunable filter.

FIGS. 3A-3B illustrate a representative method of tuning microcavities of a Fabry-Perot tunable filter in which selected microcavities are tuned to different wavelengths.

FIGS. 4A-4B illustrate a representative method of tuning microcavities of a Fabry-Perot tunable filter in which each row of microcavities is tuned to a common wavelength.

FIG. 5 illustrates a spectral imaging system that includes a Fabry-Perot tunable filter and an array image sensor.

FIG. 6 illustrates a representative arrangement of image sensor elements and LC microcavities.

FIG. 7 illustrates a method of obtaining a spectral image.

FIG. 8 illustrates a method of fabricating a Fabry-Perot (FP) tunable filter.

FIG. 9 illustrates spectral transmission of a tunable FP filter, indicating a spectral bandwidth associated with selection of a wavelength range within a selected free spectral range (FSR).

FIG. 10 illustrates spectral tuning offsets associated with microcavity fabrication variations.

FIG. 11 illustrates a representative spectral imager based on a tunable LC FP array.

FIG. 12 illustrates a spectral imager in which a tunable FP array is imaged onto an array detector.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus’ are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

As used herein, “optical radiation” refers to propagating electromagnetic radiation at wavelengths between about 100 nm and 10 μm, typically between 400 nm and 2 μm. Optical radiation is generally referred to as propagating in optical beams. As used herein, an “image” refers to a spatial distribution of optical intensity, typically a one or two dimensional distribution or an analog or digital representation of such a distribution, including stored representations in a computer readable medium or device such as RAM, ROM, or a hard disk. As used herein, “spectral image” refers to a spectrally resolved optical intensity distribution, or an analog or digital representation of a spectrally resolved optical intensity distribution stored in a computer readable medium or device such as RAM, ROM, or a hard disk. In some examples, a Fabry-Perot tunable filter is scanned over a selected wavelength range, and a series of spectral images is acquired and a spectral data cube is obtained having optical intensity as a function of wavelength and two-dimensional position. In some examples, lenses or microlenses are provided, but in other examples, mirrors, holographic optics, or other reflective or refractive optical devices can be used.

Fabry-Perot (FP) based tunable filters as disclosed herein generally include first and second reflectors situated about a liquid crystal (LC) material having an index of refraction that varies in response to an applied electric field. The first and second reflectors and the liquid crystal material generally establish an optical resonant cavity, referred to simply as an optical cavity herein. Such an optical cavity can be divided into a plurality of independently electrically tunable portions referred to as microfilters or microcavities. Typically, such microcavities have transverse dimensions less than a few mm, but the term “micro” is not intended to require a particular size or size range. In most examples, both reflectors are defined on respective substrates, and at least one of these substrates is transparent in a spectral range of interest so that optical radiation can be coupled into the optical cavity and optical microcavities. Surfaces of substrates that are closest to a Fabry-Perot cavity are referred to herein as cavity-facing. For transmissive FP tunable filters, both first and second substrates are transparent, while for reflective FP tunable filters, one of the first and second substrates is transparent and the other is reflective. As used herein, a transparent substrate is a substrate having an internal transmittance of greater than 10%, 25%, 50%, 75%, or 90% in a selected spectral range. In some cases, overall substrate transmittance can be improved with antireflection coatings.

Electrically variable optical path length is provided with one or more liquid crystal layers. Electrical signals (typically voltages) applied to a liquid crystal layer produce optical path length changes based on orientation changes in the liquid crystal layer. Alignment in liquid crystal layers is generally provided with alignment layers on opposing surfaces that contain the liquid crystal. Alignment layers can formed as rubbed polyimide layers or other layers can be used. Liquid crystal optical path differences and switching speed are typically functions of a LC layer thickness that can be established using perimeter spacers, spacers situated on portions of substrate surfaces that contain the LC layer, or with spacers distributed within the LC layer. For convenient illustration, such alignment layers and spacers are not shown in the accompanying drawings. In typical implementations, nematic liquid crystals are used.

Portions of a liquid crystal can be individually addressed so as to permit independent tuning of microcavities. Such LC portions are sometimes referred to as “pixels,” as similar independently tunable portions serve as picture elements in LC displays. LC addressing in the disclosed tunable filters can be based on so-called direct addressing in which row and column electrodes are situated on opposing sides of an LC layer. In other examples, so-called active matrix addressing is used in which row and column electrodes are situated on a common substrate and coupled via a transistor implemented as a thin film transistor (TFT) so as to regulate an applied voltage. An additional electrode is situated on an opposing side of the LC layer, but patterning of this additional electrode is not required for individual pixel control, although can be provided for other reasons, if desired.

Tunable optical path lengths in LC layers often depend on a state of polarization (SOP) of optical radiation directed into the LC layers. In some cases, one or more polarizers (and retarders) is situated to select a suitable SOP. Such polarizers can generally be situated to select a SOP prior to transmission through the LC layer or after transmission through the LC layer.

In some examples, CMOS image sensors (CIS) are used. Typical CIS devices include an array of light sensitive areas (pixels) and circuitry that scans each pixel at fixed intervals to produce an electrical signal corresponding to optical intensity at the pixels. This electrical signal is digitized to produce a digital representation of the optical intensity distribution that can be stored in a computer-readable medium. Other types of image sensors such as charge coupled devices, photodiode arrays, or sets of discrete optical detectors such as photodiodes, photovoltaic devices, or other types of optical detectors can be used. Discrete devices can be mounted and fixed in a regular array, if needed. In most applications, two dimensional arrays are preferred, but one dimensional arrays can be used.

For convenience, certain terms used associated with FP devices are described. Free spectral range (FSR) is a spectral width between adjacent FP cavity resonances.

$$FSR ∼ \frac{{λ}_{0}^{2}}{2 nL}$$

at normal incidence, wherein n and L are cavity refractive index and cavity length, respectively, and λ₀ is a free space optical wavelength. FSR varies as 1/cos(θ) wherein θ is an angle of incidence.

Similar expressions can be obtained for cavities that comprise multiple layers of different materials. FP cavity finesse is about

$$F = \frac{{π ( {R}_{1} {R}_{2} )}^{1 / 4}}{1 - {( {R}_{1} {R}_{2} )}^{1 / 2}} ,$$

wherein the FP cavity is terminated by mirrors of reflectivity R₁ and R₂. In the disclosed examples, F can be as much as 100, 200, or 500. FP resolution is generally defined as FSR/F. Reflective coatings used to define a FP cavity can be patterned or unpatterned as may be convenient. While LC tunable FP cavity length is based primarily on reflector separation and LC layer thickness, penetration of optical radiation into reflective coatings can also contribute to cavity length (and vary FSR). In some cases, such variation is wavelength dependent and an LC cavity can be calibrated to accommodate such variability.

The disclosed systems and devices can be rugged and compact, and can provide rapid spectral imaging and many applications are possible. Typical applications include pharmaceutical and medical applications, such as skin cancer detection and, pharmaceutical counterfeit detection. Other applications include atmospheric sensing.

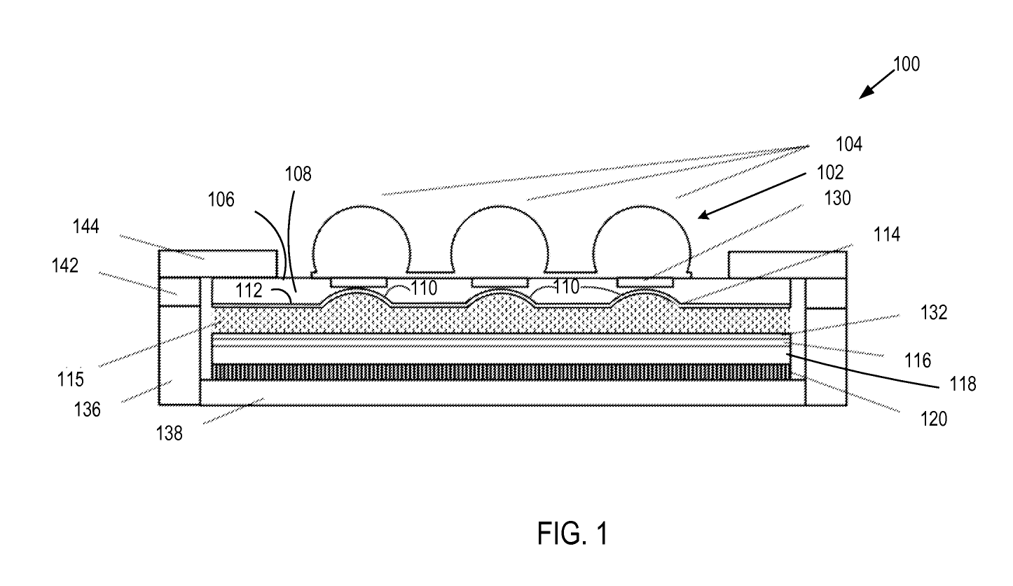

With reference to FIG. 1, a representative FP tunable filter 100 includes a microlens array 102 that includes a plurality of microlenses 104 that can be secured to a first surface 106 of a substrate 108 or integrally formed in the substrate 108. Alternatively, the microlens array 102 can be situated proximate the substrate 108 so that a position of the microlens array 102 can be adjusted with respect to individual FP microcavities as described in detail below. A plurality of curved surface portions 110 are also formed on a second surface 112 of the substrate 108, and a first dielectric coating 114 is provided on the second surface 112, either on the entire second surface 112 or at the curved surface portions 110. As shown in FIG. 1, the curved surface portions 110 correspond to depressions in the second surface 112. Typically, the curved surface portions 110 are arranged in a regular array that corresponds to the arrangement of the microlenses 102.

A liquid crystal layer 115 is situated between the first dielectric coating 114 and a second dielectric coating 116 that is situated on a second substrate 118, such as a silicon substrate or other substrate that is suitably transmissive in a spectral region of interest. The second substrate 118 can be secured to a CCD image sensor 120 (or other image sensor) or can be spaced apart from the CCD image sensor 120 with an additional transparent substrate. In some examples, the second substrate 118 is glued to an image sensor window or cover plate with an optical adhesive. Conductive electrodes 130, typically formed of a transparent conducive material such as indium tin oxide, are provided at the first surface 106 of the first substrate 108. Alternatively, the conductive electrodes 130 can be situated between the dielectric coating 114 and the second surface 112 or other convenient location. An additional conductive layer 132 can be situated between the second substrate 118 and the second dielectric coating 116 or on a cavity-facing surface of the second dielectric coating 118.

The image sensor 120 includes an array of photodetectors or photosensitive regions, referred to herein as pixels, and the microlenses 104 are aligned so as to be approximately centered with respect to corresponding image sensor pixels or sets of such pixels. The FP tunable filter 100 can be secured to or retained by a housing that comprises housing portions 136, 138. A piezoelectric device 142 is coupled to the first substrate 106 via a housing portion 144 to permit adjustment of a separation between the first dielectric coating 114 and the second dielectric coating 116 as well as to align the microlenses 130.

The first dielectric coating 114 and the second dielectric coating 116 are generally highly reflective in a wavelength range of interest and serve to define a Fabry-Perot cavity having an optical path length that is variable in response to displacements introduced with the piezoelectric device 142 and orientation or other electro-optical property of the liquid crystal layer 115. The Fabry-Perot tunable filter of FIG. 1 uses a planar reflector (the second dielectric coating 116) and concave reflectors (dielectric coated surface portions 110). One or more curved reflective surfaces can increase fabrication tolerances and provide improved Fabry-Perot finesse, and cavities can be symmetric or asymmetric. Curved or planar reflective surfaces can be used for one or both reflective surfaces. Conductive coatings are preferably situated external to the FP optical cavity, i.e., not between the first and second dielectric coatings 114, 116 so that any associated losses are external to the FP cavity, and do not reduce finesse.

The piezoelectric device 142 can adjust a spacing of the first substrate 108 and the second substrate 118 so as to adjust cavity length of all microcavities. The LC layer can be used to adjust cavity length (i.e., optical path length) based on voltages applied to the conductive electrodes 130, 132.

The curved surface portions 110 can be formed by laser ablation using optical pulses from a CO₂ laser (10.6 μm) or at another wavelength that is absorbed by a selected substrate material. Representative materials include glass and fused silica. In one example, a CO₂ laser beam is focused to a 20 μm (1/e²) spot on a fused silica substrate surface with a pulse duration of between 10 μs and 100 μs with an axial fluence of about 25 J/cm² (pulse energy of about 3 mJ). Laser beam quality corresponding to M²<1.2 is preferred. Surface depressions of diameters less than 50 μm, depths less than 800 nm, and radius less than 800 μm can be produced. A series of such exposures is used to produce an array of curved surface portions as shown in FIG. 1. Center-to-center spacings of 10 μm to 20 μm can be produced to match liquid crystal and image sensor array dimensions. After curved surface portions are produced, a dielectric coating is applied to serve as a cavity end mirror. Smooth surfaces (rms roughness <0.34 nm) can be produced so that high reflectivity dielectric coatings can be successfully applied. Depths are somewhat variable, but liquid crystal tuning can be used to correct for depth variations among the ablated areas.

A liquid crystal layer thickness can be selected based on a desired free spectral range and resolution, and achievable values of finesse. Liquid crystal layers are generally selected to tune over a full free spectral range. LC tunable refractive index differences can be as large as 0.3 so a ½ wave phase difference at most wavelengths of interest can be produced with LC layer thickness of a few microns. Typical thicknesses range from about 1 μm to about 100 μm, 1 μm to about 50 μm, 1 μm to about 20 μm, or 1 μm to about 10 μm.

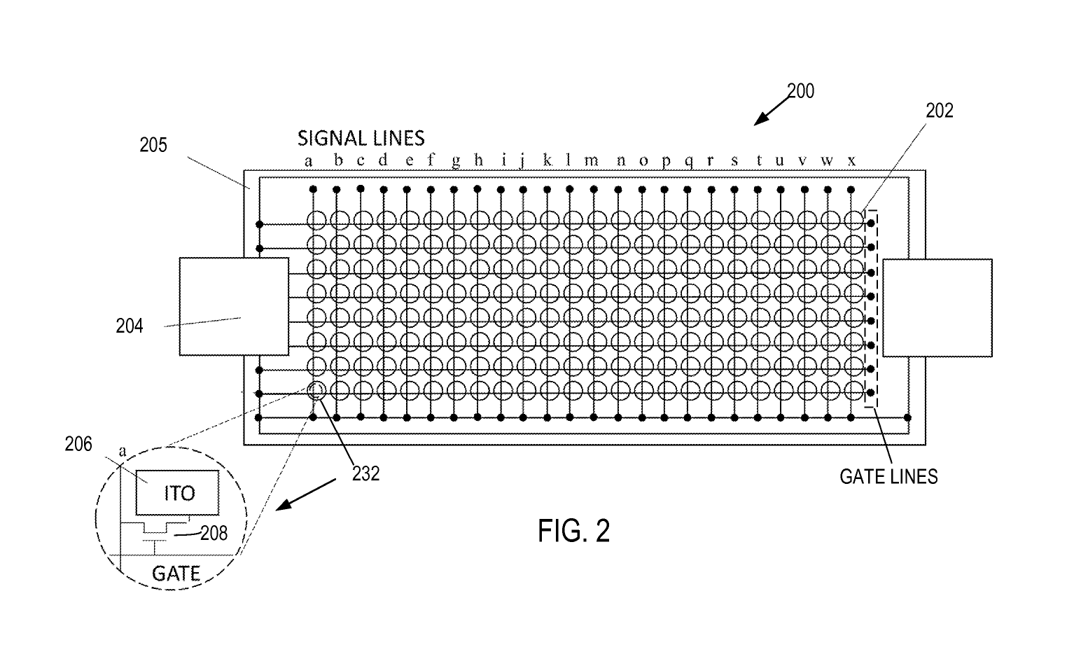

With reference to FIG. 2, a representative active matrix addressed, tunable LC array 200 for use in a Fabry-Perot tunable filter includes a plurality of LC regions (for example, region 202) that are situated at or near intersection of signal lines (a-x) and perpendicular gate lines. The LC array 200 is coupled to support members 204, 205 so that the LC array 200 can be aligned with microlens arrays and/or an image sensor. Each of the LC regions is associated with a conductive ITO electrode and a transistor. For example, a representative LC region 232 is associated with a conductive electrode 206 and a transistor 208 that is coupled to a signal line and a gate line. Voltages applied to the signal and gate lines thus permit control of a voltage on the electrode 206, permitting control of an associated LC region. (An additional conductive electrode on an opposing side of the associated LC layer is not shown.) With the arrangement of FIG. 2, each of the LC regions can be individually tuned using suitable voltages applied to the associated transistors. Thus, each FP microcavity can be tuned substantially independently of others.

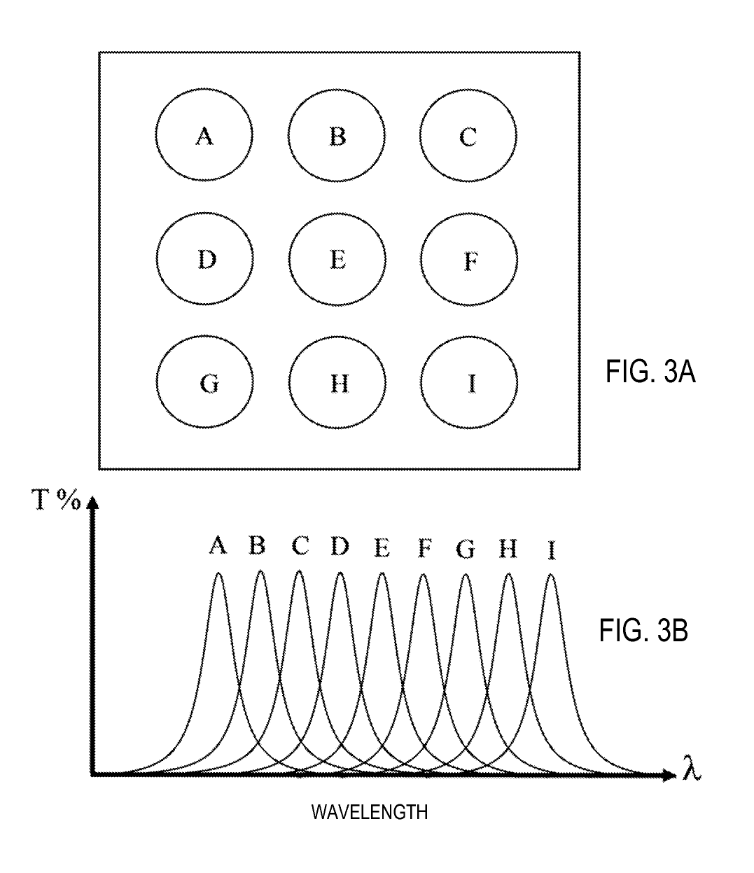

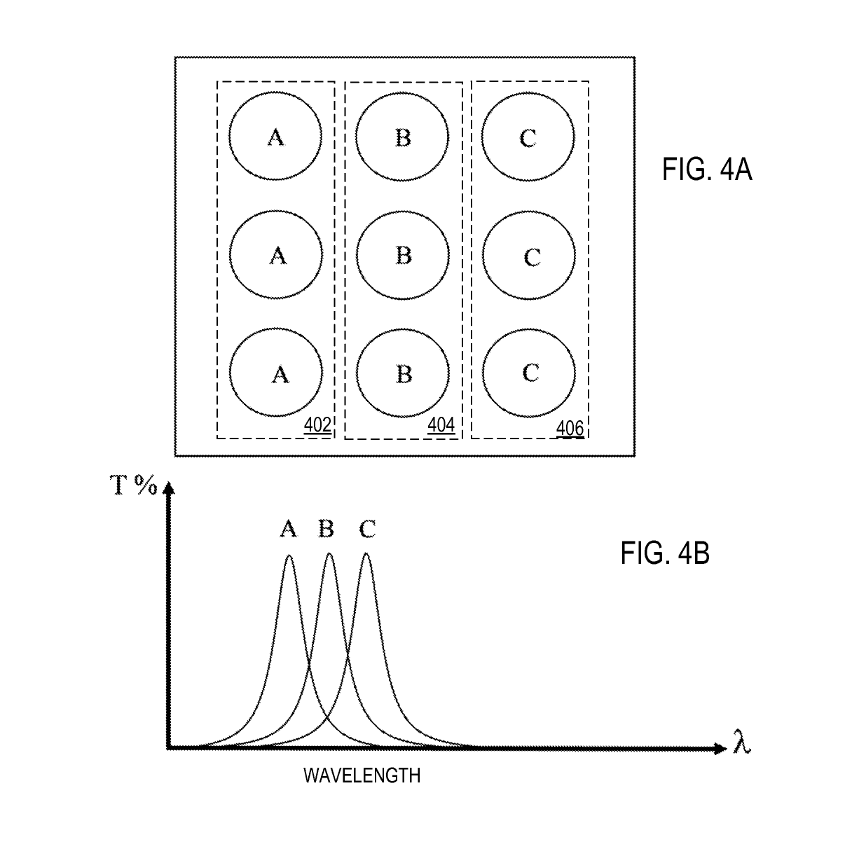

A representative method of driving an FP tunable filter array is illustrated in FIGS. 3A-3B. A plurality of FP microcavities A-I are driven so that each provides a maximum transmission at a different respective wavelength. In this example, each FP microcavity of an array is tuned to a different wavelength as shown in FIG. 3B. Another representative method of driving a tunable FP array is illustrated in FIGS. 4A-4B. Microcavity rows 402, 404, 406 are tuned to respective common wavelengths A-C having transmittances as shown in FIG. 4B. Other groupings can be tuned in common, such as rows, or other two-dimensional portions of an array of microcavities. The tunings A-C can be correspond to sequential wavelengths sequential and LC microcavity rows sequentially tuned over a desired range. For example, an array with n rows could be tuned so that each row is offset from an adjacent row about FSR/n or by 1/n of some other scan range. Alternatively, adjacent rows could be tuned to wavelengths separated by microcavity resolution, with or without scanning

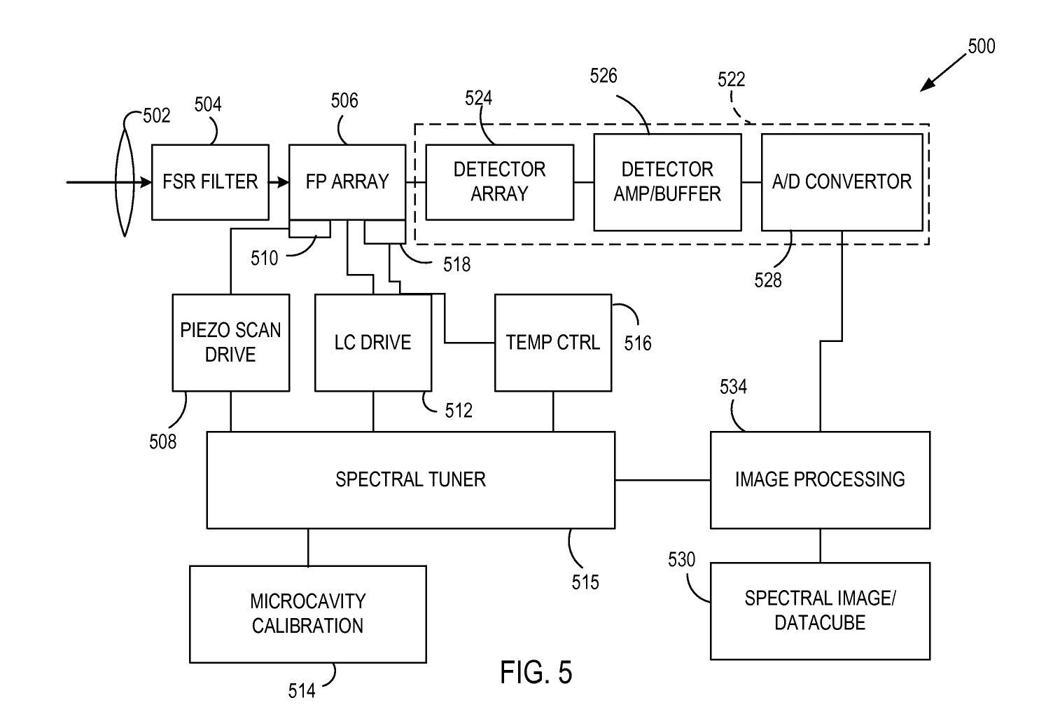

Referring to FIG. 5, a representative FP tunable filter system 500 includes an optical system 502 that produces an image of a region of interest that is directed through a free spectral range (FSR) filter 504 or other filter to a FP liquid crystal tunable filter array 506. The FP array 506 is coupled to a piezoelectric drive 508 that provides a suitable voltage or range of voltages to a piezoelectric device 510 that can adjust a FP cavity length. In some examples, piezoelectric elements are not used, or can be used for scanning in conjunction with or in addition to liquid crystal based scanning, or the piezoelectric device 510 can be used to set a particular cavity length and scanning provided with a liquid crystal element.

The FP array 506 is also coupled to a liquid crystal driver 512 that provides suitable electrical signals to microcavities of the FP array 506 so as to vary or establish cavity lengths for some or all microcavities of the FP array 506. In some examples, the liquid crystal driver 512 can be provided as a liquid crystal display driver so that wavelength tunings settings such as scan range, drive levels for some or all wavelengths, bias drive levels to establish a selected initial or other wavelength can be coupled to some or all microcavities. Alternatively the liquid crystal driver 512 can be provided with dedicated circuit elements that can provide drive signals similar to those provided with display drivers, or larger, smaller, faster, or slower drive signals as preferred. As shown in FIG. 5, drive levels are based on tuning wavelength and calibration settings that can be stored and recalled from a memory 514, and are provided to the LC driver 512 so as to correspond to image display values. A spectral tuner 515 select piezoelectric drive levels, processes LC drive values, and is coupled to a temperature controller 516. A temperature control element (such as a temperature sensor and/or thermoelectric device) 518 is coupled to the temperature controller to establish a temperature of the FP array 506. FP array temperature can be selected to provide selected FP microcavity lengths, to maintain consistent FP array spectral properties in the presence of external temperature changes, or to control or adjust LC switching speeds.

An imaging system 522 includes a detector array 524, a detector amplifier/buffer 526, and an analog-to-digital convertor (A/D) 528. The detector array 524 is typically a CCD or CMOS array that includes a two dimensional array of photosensors such as photodiodes. The detector amplifier/buffer 526 and the A/D 528 process signals from the photosensors corresponding to a local input optical intensity to produce image signals or image data that is coupled to a memory 530 for storage. As noted above, one or two dimensional detector arrays can be used, and a series of spectral images can be obtained and the associated spectral datacube stored in the memory 530. In some examples, the imaging system 522 is implemented as a series of discrete components similar to the arrangement of FIG. 5, but other arrangements integrated image sensors/processing electronics can be used. In some examples, an image processor 534 receives tuned images and combines images based on wavelength tuning patterns (such as shown in FIGS. 4A-4B-5A-5B) to produce a spectral datacube.

The FSR 504 is selected to transmit spectral portions of the input image so as to reduce or eliminate optical power that reaches a detector that is outside of a selected spectral window of interest. Typically, the FSR 504 transmits optical power at wavelengths that are within a range that is less than or equal to one free spectral range. In this case, the periodic transmission of the FP array does not result in optical intensity at multiple FP resonance wavelengths reaching the detector array 524. The pre-filter can be a multilayer coated band pass filter having pass band that is less than a free spectral range, or a series of dielectric edge filters, or one or more absorptive filters can be used. Other spectrally selective optical elements such as diffraction gratings, holographic optical elements, or reflective filters can also be used. The FSR filter can be situated optically before or after the FP microcavity array.

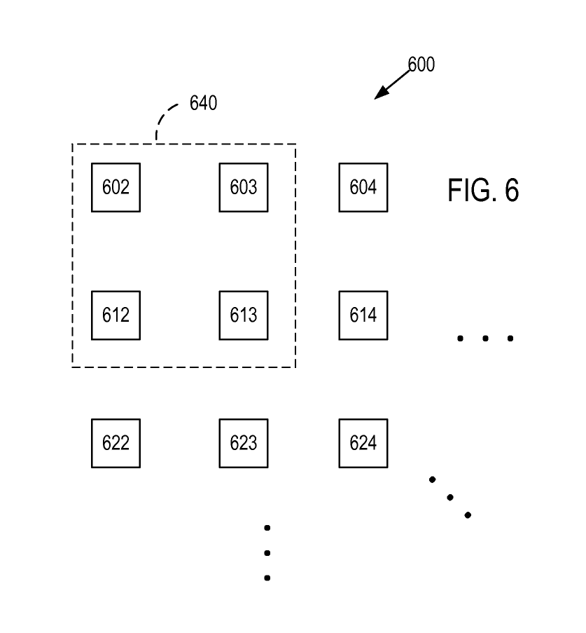

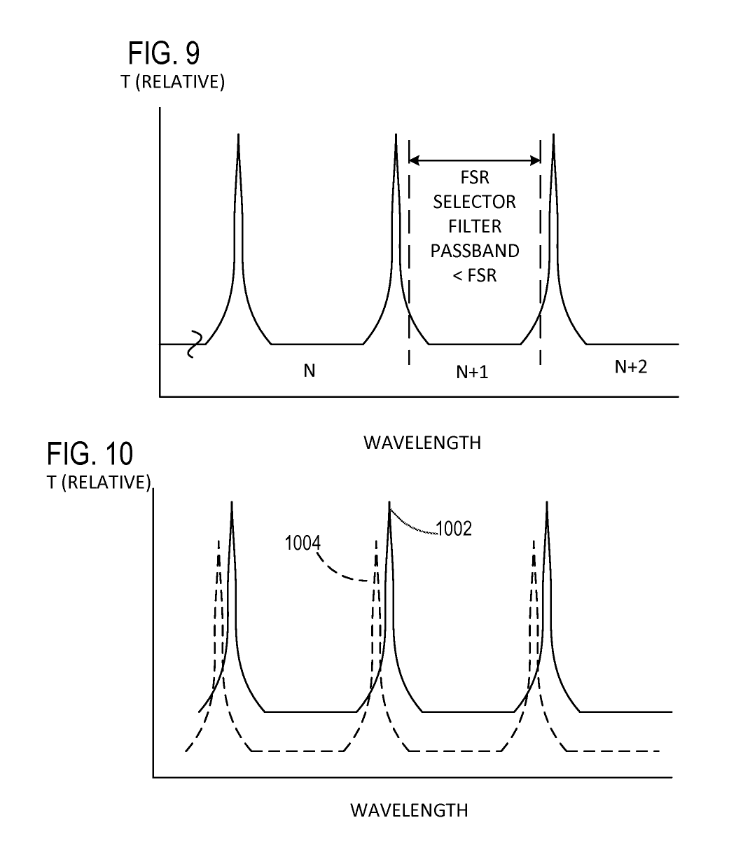

While in some examples, LC microcavities are arrange to align with corresponding image detector pixels, other arrangements can be used. For example, as shown in FIG. 6, an array 600 of image pixels is situated so that optical radiation from an LC microcavity 640 is directed to image sensor elements 602, 603, 612, 613. Alternatively, a single LC microcavity can be situated to direct filtered optical radiation to image sensor elements arranged in a column such as image sensor elements 603, 613, 623 or image sensor elements arranged in a row such as image sensor elements 622, 623, 624. Different FSR selecting filters can be applied to each of the multiple image sensor elements associated with a single LC microcavity to extend a spectral analysis range to more than one FSR. For example, as shown in FIG. 9, an N^{th} FSR and an (N+1)^{th} FSR corresponding to different wavelength ranges can be assigned to different image sensor elements, and scanned simultaneously. In other examples, a single image sensor element can be situated to receive filtered optical radiation from multiple LC microcavities.

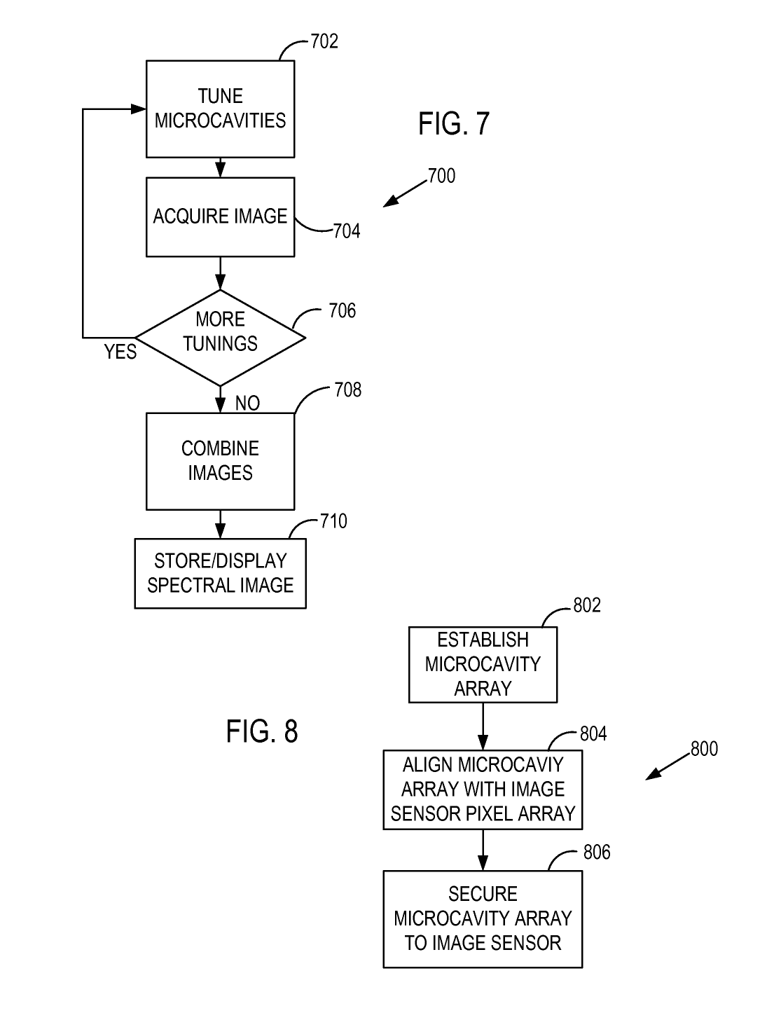

Referring to FIG. 7, a method 700 of obtaining spectral images includes tuning a plurality of FP cavities (typically, LC microcavities) at 702 and acquiring a spectral image at 704. At 706, it is determined if additional tunings are to be used. If so, 702, 704 are repeated with a different tuning. If spectral images associated with all selected tunings have been acquired, images from the multiple spectral tunings are combined as 708 and a combined spectral image or portions thereof are stored at 710. As noted above, all LC microcavities of an array can be tuned to a common wavelength, and scanned by scanning the common wavelength. However, some or all LC microcavities can be tuned to different wavelengths, so that a particular spectral image from a single tuning contain spectral data for different wavelengths at different image pixels. Using a table of tunings, such spectral images can be combined to produce, for example, a spectral datacube.

A method 800 of making a spectral imager includes forming an array of tunable FP filters at 802 and aligning the tunable FP filters with an image sensor pixel array at 804. Typically, the array of tunable FP filters is based on an array of LC tunable FP microcavities. At 806, the image sensor is secured to the array of tunable FP filters.

FIG. 9 illustrates the periodically varying transmittance associated with an FP tunable filter. For a fixed tuning, optical radiation at a plurality of wavelengths can be transmitted. By providing an optical filter (referred to herein as an FSR selector or FSR filter) having a passband corresponding to an Nth FSR, radiation in other FSRs can be rejected. If an FSR is sufficiently large so that all input optical radiation spans a wavelength range that is less than one FSR, such filtering is generally unnecessary. In some cases, FP reflectors are sufficiently narrowband so that cavity resonance extends over a small spectral window, and additional filtering is avoided.

As shown in FIG. 10, LC microcavities can have slightly different cavity lengths or other characteristics so as to tune differently with common tuning voltages. For example, spectral curves 1002, 1004 correspond to different LC microcavities, nominally tuned to a common wavelength. The LC microcavities can be calibrated by tuning to a common wavelength, and the associated tuning parameters (such as LC drive voltage, piezoelectric drive voltage, temperature) selected so an array can be set to a common wavelength using the stored values.

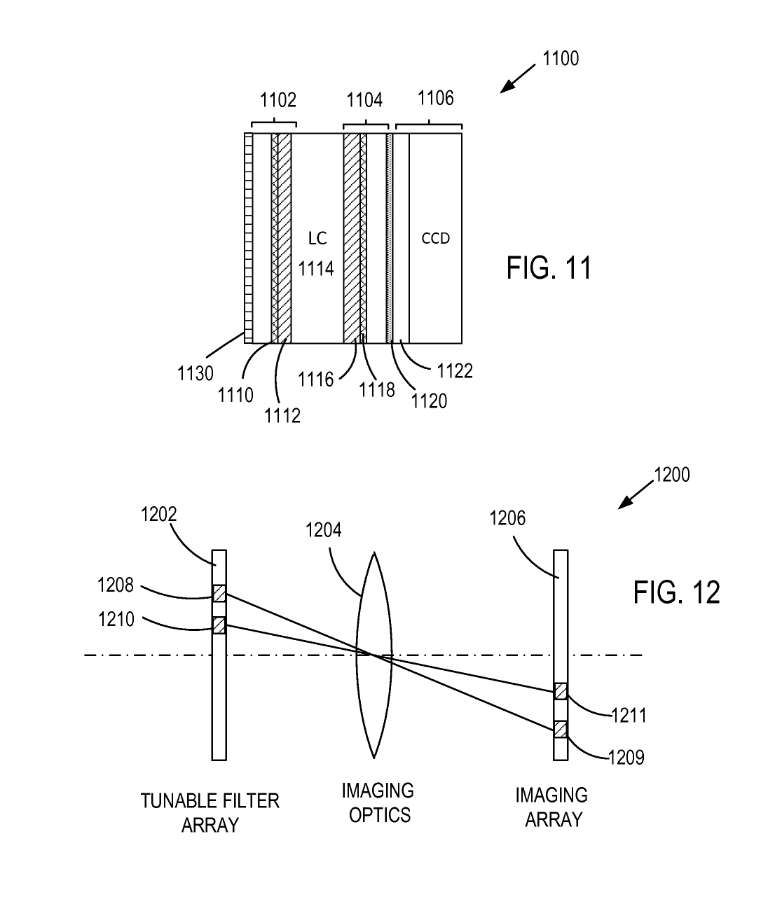

A representative FP tunable filter array 1100 is shown in FIG. 11. A first transparent substrate 1102 includes a conductive coating 1110 and a reflective coating 1112. A second substrate 1104 includes a conductive coating 1118 and a reflective coating 1116. An LC layer 1114 is situated between the substrates 1102, 1104. The substrate 1104 is secured to a window 1122 of a CCD image sensor 1106 with a layer 1120 of an optical adhesive. The conductive coatings 1110, 1118 can be patterned for active or passive LC addressing, and the LC assembly can be fixed to the CCD image sensor 1106 with a housing, a mechanical assembly, or otherwise. If needed, a polarizer 1130 can be secured to the first substrate 1102. Alignment layers, microlenses, additional filters, and electrical connections and patterning of conductive layers are not shown for convenient illustration. As shown in FIG. 11, two planar reflectors can be used, and microlenses and substrate surface depressions are not required.

FIG. 12 illustrates a tunable FP array 1202 that is imaged by a lens 1204 at an image sensor 1206. As shown in FIG. 12, LC microcavities 1208, 1210 are imaged to image sensor pixels 1209, 1211, respectively. The tunable FP array 1202, the lens 1204, and the image sensor 1206 can be secured in a common optical mount or otherwise secured. The configuration of FIG. 12 shows that while integral LC array/sensor array systems can be used, an LC array and a sensor array can be coupled in other ways.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim as our invention all that comes within the scope and spirit of the appended claims.

1. An optical device, comprising:
first and second reflectors;
a liquid crystal layer situated between the first and second reflectors, the liquid crystal layer and the first and second reflectors defining an optical cavity;
first and second conductive electrodes situated to define a plurality of electrically controllable microcavities in the optical cavity.

2. The optical device of claim 1, wherein at least one of the first and second conductive electrodes includes a plurality of microcavity electrodes that define the electrically controllable microcavities.

3. The optical device of claim 1, wherein at least one of the first and second conductive electrodes is situated external to the optical cavity.

4. The optical device of claim 1, further comprising:
a first transparent substrate, wherein the first reflector is situated at a cavity-facing surface of the first transparent substrate; and
a second transparent substrate, wherein the second reflector is situated at a cavity-facing surface of the second transparent substrate.

5. The optical device of claim 4, wherein the first and second conductor electrodes are arranged so as to form a microcavity electrode array, and the cavity-facing surface of the first substrate includes a plurality of concave portions, each concave portion corresponding to a respective microcavity.

6. The optical device of claim 1, wherein the first and second reflectors are dielectric reflectors having reflectivities of at least 90% in a selected spectral range.

7. The optical device of claim 1, wherein the first conductive electrode includes a plurality of microcavity electrodes that define the electrically controllable microcavities, and further comprising a plurality of transistors, each of the plurality of transistors coupled to a respective microcavity electrode.

8. The optical device of claim 1, further comprising a microlens array secured to a surface of the first substrate that is opposite the cavity-facing surface, wherein each lens of the microlens array is situated along an axis of a respective microcavity.

9. A spectral imager, comprising:
a Fabry-Perot tunable filter having a plurality of liquid crystal tunable microcavities; and
an image sensor optically coupled to the Fabry-Perot tunable filter.

10. The spectral imager of claim 9, wherein the image sensor includes a plurality of pixels, and the liquid crystal tunable microcavities are situated so as to be optically coupled to corresponding image sensor pixels.

11. The spectral imager of claim 10, wherein the Fabry-Perot tunable filter includes a substrate having a high reflectance coating on a microcavity-facing surface, and the substrate is secured to the image sensor.

12. The spectral imager of claim 9, wherein each microcavity is coupled to different image sensor pixels.

13. The spectral imager of claim 9, wherein the Fabry-Perot tunable filter includes an array of tunable microcavities and the image sensor includes an array of pixels

14. The spectral imager of claim 9, wherein the Fabry-Perot tunable filter includes first and second substrates having high reflectivity coatings on respective microcavity-facing surfaces, a liquid crystal layer situated between the first and second substrates, and the image sensor includes an image sensor window, further wherein one of the first and second substrates is fixed to the image sensor window.

15. A method of making a spectral imager, comprising:
defining an array of liquid crystal (LC) microcavities; and
securing the array of LC microcavities to an image sensor array so that the LC microcavities are optically coupled to respective sensors of the image sensor array.

16. The method of claim 15, wherein the array of LC microcavities is defined by:
forming a first reflective coating in a selected spectral region on a first substrate;
forming a second reflective coating in the selected spectral region on a second substrate; and
situating an LC layer between the first and second reflective coatings.

17. The method of claim 15, further comprising situating the array of LC microcavities between a first conductive coating and a second conductive coating, wherein at least one of the first conductive coating and the second conductive coating is patterned so as to define the LC microcavities.

18. The method of claim 16, further comprising ablating an array of regions in a surface of the first substrate, wherein the first reflective coating is formed on the array of ablated regions.

19. The method of claim 16, further comprising securing a microlens array with respect to the array of LC microcavities so that the microlenses are situated to direct input optical radiation to associated LC microcavities and corresponding image sensor pixels.

20. A spectral imager, comprising:
a tunable filter, the tunable filter defined by a liquid crystal layer situated between first and second transparent substrates, the first transparent substrate having an array of surface depressions and a dielectric coating at the surface depressions, the second substrate having a dielectric coating, wherein the dielectric coatings of the first and second substrates and the array of depressions define an array of liquid crystal Fabry-Perot cavities;
an image array secured to the tunable filter, so that the liquid crystal Fabry-Perot cavities are optically coupled to corresponding photodetectors of the image array; and
a piezoelectric device coupled to at least one of the first and second substrates so as to adjust a spacing of the first and second substrates;
a liquid crystal driver and a piezoelectric driver coupled to the tunable filter so as to select a plurality of wavelengths for each of the liquid crystal Fabry-Perot cavities; and
a processor that receives images from the image array and provides a spectral data cube based on the images.
